(19) United States
(12) Patent Application Publication
(10) Pub. No.: US 2018/0275154 A1
(43) Pub. Date: Sep. 27, 2018

(54) CARTRIDGE, DETECTING DEVICE, AND DETECTING METHOD

(71) Applicant: SONY CORPORATION, TOKYO (JP)

(72) Inventor: NAOKI MORIMOTO, TOKYO (JP)

(21) Appl. No.: 15/746,009

(22) PCT Filed: May 25, 2016
(86) PCT No.: PCT/JP2016/065418

§ 371 Date: Jan. 19, 2018

(30) Foreign Application Priority Data
Aug. 7, 2015 (JP) 2015-157094

(51) Int. Cl. G01N 35/02; B01L 3/00

(52) U.S. Cl. CPC G01N 35/02; B01L 3/502; B01L 2200/14; B01L 2300/18; B01L 2200/16; B01L 3/508

(57) ABSTRACT

A technology capable of easily preventing erroneous reuse of a used cartridge is provided.

Provided is a cartridge at least including a sample holding unit for holding a sample containing a detection target substance to be detected by a detecting device, and an irreversible variable portion capable of irreversibly physically changing arranged in a position corresponding to a distinguishing unit of the detecting device when being installed in the detecting device.

### TECHNICAL FIELD

The present technology relates to a cartridge, a detecting device, and a detecting method.

### BACKGROUND ART

In recent years, importance of analysis/measurement on site where the analysis/measurement is required or in the vicinity of the site (hereinafter, referred to as “POC analysis and the like”) such as analysis for bedside diagnosis to perform measurement necessary for medical diagnosis in the vicinity of a patient (point of care (POC) analysis), analysis of harmful substances in rivers and waste materials on site such as the rivers and waste sites, and contamination test on each site of food preparation, harvest, and import attracts attention.

In this POC analysis and the like, a cartridge for holding a sample containing a detection target substance is used (for example, refer to Patent Documents 1 and 2). Various samples such as biological samples are used as this sample, and these samples remain in the cartridge after the analysis is finished. Therefore, when the used cartridge is reused, an incorrect analysis result is obtained by contamination.

Herein, the cartridge disclosed in Patent Documents 1 and 2 may also be used as disposable. However, even if the cartridge is disposable, it is impossible to avoid a risk of reuse unless it is possible to instantaneously distinguish whether this is used or unused.

As a method of avoiding the risk of reuse, there may be measures that an operator writes a character and the like in the disposable cartridge indicating that this is used, sticks a seal or the like after the analysis is finished, thereby distinguishing the used cartridge from the unused cartridge. However, even if the operator takes such measures, it is troublesome to write in such a manner each time the cartridge is used, and there is a possibility of erroneously writing that the cartridge is used in the unused cartridge or forgetting writing in the used cartridge.

In addition, there may be a method of assigning a unique ID to the disposable cartridge and detecting the ID by a read-only device, thereby distinguishing the used cartridge from the unused cartridge, for example. However, in this method, it is troublesome to issue the unique ID for each cartridge, and it is also necessary to install a dedicated device for reading the ID. Furthermore, in a facility where two or more detecting devices are installed, in order to make it possible to distinguish by other devices after the analysis is finished, it is necessary to have almost real-time database sharing between the devices. Additionally, in this method, it is impossible for the operator to visually confirm.

### CITATION LIST

### Patent Document

### Patent Document 1: Japanese Patent Application Laid-Open No. 2004-028589

### Patent Document 2: Japanese Unexamined Patent Publication No. 2001-527220

### SUMMARY OF THE INVENTION

### Problems to be Solved by the Invention

As described above, there is a problem that it is very difficult to easily distinguish between used and unused cartridges in the conventional cartridge.

Therefore, a main object of the present technology is to provide a technology of easily preventing erroneous reuse of the used cartridge.

### Solutions to Problems

As a result of serious research to solve the above-described object, the inventor of the present application succeeded in easily preventing erroneous reuse of a used cartridge by paying attention to a structure of the cartridge, thereby completing the present technology.

That is, the present technology first provides a cartridge at least including a sample holding unit for holding a sample containing a detection target substance to be detected by a detecting device, and an irreversible variable portion capable of irreversibly physically changing arranged in a position corresponding to a distinguishing unit of the detecting device when being installed in the detecting device.

In the present technology, a structure of the irreversible variable portion is not especially limited; this may be made a fracture structure that fractures by installation in the device. Also, the fracture structure is not especially limited, and this may be a film-shaped structure.

In the present technology, the sample is not especially limited; this may be a biological sample.

Also, the present technology provides a detecting device at least provided with a cartridge installing portion in which a cartridge is installed, a distinguishing unit which distinguishes whether an irreversible variable portion of the cartridge is in a state before change or a state after change, and a detecting unit which detects a detection target substance contained in a sample held by a sample holding unit of the cartridge. In the present technology, a change inducing unit which induces physical change in the irreversible variable portion may be provided in the cartridge installing portion. Also, in the present technology, the cartridge installing portion is provided with a movable portion movable according to a distinguishing result of the distinguishing unit, and the movable portion may prevent installation of the cartridge in the cartridge installing portion in a case where the irreversible variable portion is in the state after change. The detecting device according to the present technology is further provided with a control unit which controls start of detection on the basis of a distinguishing result of the distinguishing unit, and the control unit may be such that this does not start the detection in a case where the irreversible variable portion is in the state after change.

Furthermore, the present technology provides a detecting method at least performing an installing step of installing a cartridge in a detecting device, a distinguishing step of distinguishing whether an irreversible variable portion of the cartridge is in a state before change or a state after change, and a detecting step of detecting a detection target substance contained in a sample held by a sample holding unit of the cartridge.

The detecting method according to the present technology may further include a change inducing step performed at least after the distinguishing step and inducing physical change in the irreversible variable portion. In the present technology, the change inducing step may be performed simultaneously with the detecting step. Also, in the present technology, the change inducing step may be performed simultaneously with the installing step.

Furthermore, in the present technology, the distinguishing step and the change inducing step may be performed simultaneously with the installing step.

The detecting method according to the present technology may further include an ejecting step of ejecting the cartridge from the detecting device, and the change inducing step may be performed simultaneously with the ejecting step.

### Effects of the Invention

According to the present technology, it is possible to easily prevent erroneous reuse of a used cartridge.

Meanwhile, the effects are not necessarily limited to the effects herein described and may be any of the effects described in the present technology.

### BRIEF DESCRIPTION OF DRAWINGS

FIG. 1 is a schematic diagram schematically illustrating a first embodiment of a cartridge 1 according to the present technology.

FIG. 2 is a schematic conceptual diagram schematically illustrating a first embodiment of a detecting device 10 according to the present technology.

A to C of FIG. 3 are schematic diagrams illustrating a state in which the cartridge 1 (unused) according to the present technology is installed in a cartridge installing portion 2.

A to C of FIG. 4 are schematic diagrams illustrating a state in which the cartridge 1 (unused) according to the present technology is installed in the cartridge installing portion 2 different from that in FIG. 3.

A to C of FIG. 5 are schematic diagrams illustrating a state in which the cartridge 1 (unused) according to the present technology is installed in the cartridge installing portion 2 different from those in FIGS. 3 and 4.

A to C of FIG. 6 are schematic diagrams illustrating a state when the cartridge 1 (unused) according to the present technology is installed in the cartridge installing portion 2 different from those in FIGS. 3 to 5.

A to C of FIG. 7 are schematic diagrams illustrating a state when the cartridge 1 (used) according to the present technology is about to be installed in the cartridge installing portion 2.

A to C of FIG. 8 are schematic diagrams illustrating a state when the cartridge 1 (unused) according to the present technology is installed in the cartridge installing portion 2 different from those in FIGS. 3 to 6.

A and B of FIG. 9 are schematic diagrams illustrating a state when the cartridge 1 (used) according to the present technology is about to be installed in the cartridge installing portion 2 different from that in FIG. 7.

FIG. 10 is a schematic conceptual diagram schematically illustrating a second embodiment of a detecting device 10 according to the present technology.

FIG. 11 is a schematic conceptual diagram schematically illustrating a third embodiment of a detecting device 10 according to the present technology.

FIG. 12 is a schematic diagram schematically illustrating a first embodiment of a detecting kit K.

FIG. 13 is a flowchart illustrating an example of a flow of detection using a detecting method according to the present technology.

FIG. 14 is a flowchart illustrating an example of a flow of the detection using the detecting method according to the present technology different from that in FIG. 13.

FIG. 15 is a flowchart illustrating an example of the flow of the detection using the detecting method according to the present technology different from those in FIGS. 13 and 14.

FIG. 16 is a flowchart illustrating an example of the flow of the detection using the detecting method according to the present technology different from those in FIGS. 13 to 15.

### MODE FOR CARRYING OUT THE INVENTION

Hereinafter, a preferred mode for carrying out the present technology is described with reference to the drawings. The embodiment hereinafter described illustrates an example of a representative embodiment of the present technology, and the scope of the present technology is not narrowed by them.

Meanwhile, the description is given in the following order.

### 1. Cartridge 1

### (1) Entire Structure

### (2) Sample Holding Unit 11

### (3) Irreversible Variable Portion 12

### (4) Reagent Holding Unit 13

### 2. Detecting Device 10

### (1) Cartridge Installing Portion 2

### (a) Change Inducing Unit 21

### (b) Movable Portion 22

### (2) Distinguishing Unit 3

### (3) Detecting Unit 4

### (4) Control Unit 5

### (5) Distinguishing Result Display Unit 6

### (6) Cartridge Installation Detecting Unit 7

### (7) User Interface

### (8) Analyzing Unit

### (9) Others

### (a) Light Irradiating Unit

### (b) Optical Controlling Mechanism

### (c) Light Detecting Unit

### 3. Detecting Kit K

### (1) Sample Introducing Member 8

### 4. Detecting Method

### (1) Installing Step (I)

### (2) Distinguishing Step (II)

### (3) Detecting Step (III)

### (4) Change Inducing Step (IV)

### (5) Ejecting Step (V)

### (6) Others

<1. Cartridge 1>

### (1) Entire Structure

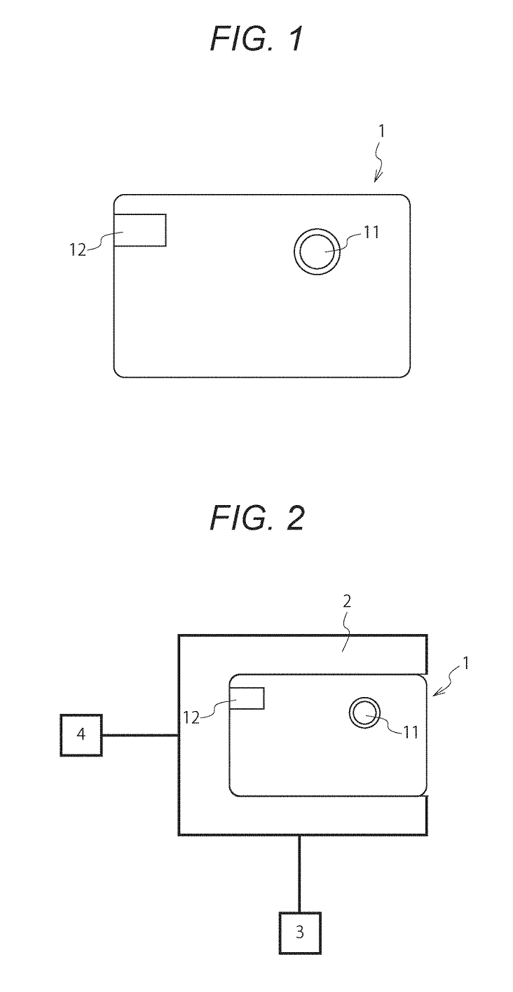

FIG. 1 is a schematic diagram schematically illustrating a first embodiment of a cartridge 1 according to the present technology.

The cartridge 1 according to the present technology is roughly provided with a sample holding unit 11 and an irreversible variable portion 12. It is also possible to be further provided with a reagent holding unit 13 and the like, as necessary.

Meanwhile, in each drawing, the irreversible variable portion 12 before change is indicated in white, and the irreversible variable portion 12 after change is indicated in black as a matter of convenience.

As long as the cartridge 1 according to the present technology is provided with the above-described units, a method of forming the same is not especially limited; it is also possible to form the same by bonding a plurality of substrates, for example. A material forming the substrate is not especially limited, and a material which may be used in a light detecting cartridge and the like such as a bioassay cartridge may be freely selected to be used in general. For example, it is possible to use a substrate of light-transmissive plastic resin such as polycarbonate, polyolefin series, and acrylic series, silicon resin such as polydimethylsiloxane (PDMS), glass and the like.

Hereinafter, each unit of the cartridge 1 according to the present technology is described in detail.

(2) Sample Holding Unit 11

The sample holding unit 11 is a portion for holding a sample containing a detection target substance to be detected by a detecting device.

In the present technology, the detection target substance is not especially limited, and examples thereof include a substance contained in the sample, a substance obtained by chemically modifying and the like the substance or the like, for example. Also, the sample is not especially limited, and examples thereof include a biological sample and the like, for example. Examples of the biological sample include body fluid (such as blood, serum, plasma, and urine) or diluted solution thereof, and/or a drug additive and the like, for example.

In the cartridge 1 according to the present technology, the number of the sample holding units 11 is not especially limited as long as this is at least one or larger, and this may be freely designed according to a type of the sample, the detecting device to be used and the like. For example, two or more sample holding units 11 may also be provided as illustrated in FIG. 3.

In the cartridge 1 according to the present technology, a width, a depth, a cross-sectional shape and the like of the sample holding unit 11 are not especially limited, and may be freely designed as long as an effect of the present technology is not deteriorated. For example, the cross-sectional shape may be freely designed to be a circle, a polygon (a triangle, a quadrangle, or a polygon having more angles), an ellipse, or a combination of one or two or more of them and the like.

Also, a form in a depth direction is not especially limited, and may be freely designed to be a bowl shape, a cylindrical shape, a polygonal cylindrical shape having a polygonal cross-section (triangular, quadrangular, or with more angles), a conical shape, a polygonal cone shape having a polygonal cross-section (triangular, quadrangular, or with more angles), or a combination of one or two or more of them and the like, for example.

In the present technology, it is also possible to use the sample holding unit 11 as an area for detecting while holding the sample. The detection is not especially limited, and examples thereof include optical detection and the like, for example. Also, the sample holding unit 11 may also be used as a stand-by place where the sample stands by for a certain period of time, or a reaction place where nucleic acid amplification, hybridization, and inter-substance interaction of nucleic acid, protein, cell and the like progress in addition to a detecting area.

A specific method of introducing the sample into the sample holding unit 11 is not especially limited, and it is possible to introduce the same by a free method. For example, there is a method of directly spotting the sample on the sample holding unit 11, a method of spotting/injecting and the like the sample on/to the sample holding unit 11 using a tool such as a capillary (capillary tube) and a pipette and the like.

(3) Irreversible Variable Portion 12

The irreversible variable portion 12 is a portion which is irreversibly physically changeable arranged in a position corresponding to a distinguishing unit of the detecting device when installed in the detecting device.

In the cartridge 1 according to the present technology, by setting the irreversible variable portion 12 to a state before physical change if the cartridge 1 is in an unused state and to a state after physical change if the cartridge 1 is in a used state, it is possible to distinguish whether the cartridge 1 is used. As a result, it is automatically distinguished whether the cartridge 1 according to the present technology is used. Therefore, it is not required for an operator to distinguish whether the cartridge is used, and it becomes possible to easily prevent erroneous reuse of the used cartridge. Also, since it is possible to save time and labor for the operator to confirm whether the cartridge is used, troublesome operation may be prevented.

The irreversible variable portion 12 may be irreversibly physically changed, so that the cartridge 1 according to the present technology is preferable as a disposable cartridge in view of this characteristic. Also, the physical change is not especially limited as long as this is irreversible, and examples thereof may include the physical change such as deformation, stretching, cutting, division, explosion, split, and fracture, for example.

A position of the irreversible variable portion 12 in the cartridge 1 according to the present technology is not especially limited as long as this is a position corresponding to the distinguishing unit of the detecting device; for example, there may be the position as illustrated in FIGS. 1 to 12 and the like.

In the present technology, a structure of the irreversible variable portion 12 is not especially limited; this may be made a fracture structure that fractures by installation in the device. By adopting this structure, it is possible to distinguish whether the cartridge 1 is used with a simple configuration, which may contribute to simplification of a step of manufacturing the cartridge 1, a decrease in cost of the cartridge 1, simplification of a configuration of the device and the like.

Also, in the present technology, the fracture structure is not especially limited, and this may be a film-shaped structure. By adopting the film-shaped structure, the irreversible variable portion 13 is easily fractured by a protruding structure and the like of the device at the time of installation in the device, and it is possible to distinguish whether this is used with a simpler configuration. Therefore, it is possible to contribute more to the simplification of the step of manufacturing the cartridge 1 and the simplification of the configuration of the device.

Also, in the present technology, a current fuse and the like may be provided in at least a part of the irreversible variable portion 12 as necessary. Also, as illustrated in FIG. 5 to be described later, the irreversible variable portion 12 may be such that at least a part of the irreversible variable portion 12 is recessed to be deformed and the like by the protruding structure (change inducing unit 21) pushing the irreversible variable portion 12 and the like when the cartridge 1 (unused) is inserted at the back of the cartridge installing portion 2.

In addition to this, in the present technology, it is possible to allow chemical change to occur in at least a part of the irreversible variable portion 12 as well as the physical change of the irreversible variable portion 12. The chemical change includes, for example, the chemical change such as change in color. Since the chemical change occurs in at least a part of the irreversible variable portion 12, the device, the operator and the like may double-check the portion the color of which changes and the like together with the check of the physical change to more certainly prevent the used cartridge from being erroneously reused.

A method of causing also the chemical change in at least a part of the irreversible variable portion 12 is not especially limited, and for example, there is a method of changing the color of thermal paper by heat by a laser and the like, the thermal paper provided in at least a part of the irreversible variable portion 12 and the like.

(4) Reagent Holding Unit 13

The cartridge 1 according to the present technology may further be provided with the reagent holding unit 13 in at least a part thereof as illustrated in FIG. 5. The reagent holding unit 13 is a portion for holding a reagent. Since the cartridge 1 according to the present technology is provided with the reagent holding unit 13, if the cartridge 1 in which a desired reagent is sealed in advance is purchased, the operator may perform desired detection, analysis and the like without performing operation to seal the reagent in the cartridge 1.

In the present technology, arrangement, a form and the like of the reagent holding unit 13 are not especially limited, and they may be freely designed according to a testing device to be used and the like. Also, a type, a form and the like of the reagent are not especially limited, and may be freely selected.

In the present technology, at least a part of the reagent may be made non-fluid. By making the same non-fluid, it is possible to prepare reagent solution by dissolving the non-fluid reagent in reagent solvent and the like in the cartridge 1 immediately before the detection, so that a possibility of leakage of the reagent from the cartridge 1 at the time of transportation, storage and the like is lowered, and a quality of the reagent is less likely to be deteriorated as compared to a case where a fluid reagent is sealed.

The non-fluid reagent means a solid-state reagent such as powder or a freeze-dried product or a rubber-like reagent, and may also be a reagent like thick malt syrup having viscosity so as not to flow out of the reagent holding unit 13 in a distribution process (at the time of transportation, storage and the like) of the cartridge 1. Also, a method of putting the non-fluid reagent into the reagent holding unit 13 is not especially limited, and there is a method of directly putting the non-fluid reagent into the reagent holding unit 13 by a required amount, a method of putting the solution obtained by dissolving the reagent into the reagent holding unit 13 and then drying to make the same non-fluid and the like.

The cartridge 1 according to the present technology may also be transported, stored and the like in a state in which the reagent is held in advance in the reagent holding unit 13. Also, depending on the type and the like of the reagent, the cartridge 1 may be refrigerated, frozen, freeze-dried and the like in a state in which the reagent is held.

<2. Detecting Device 10>

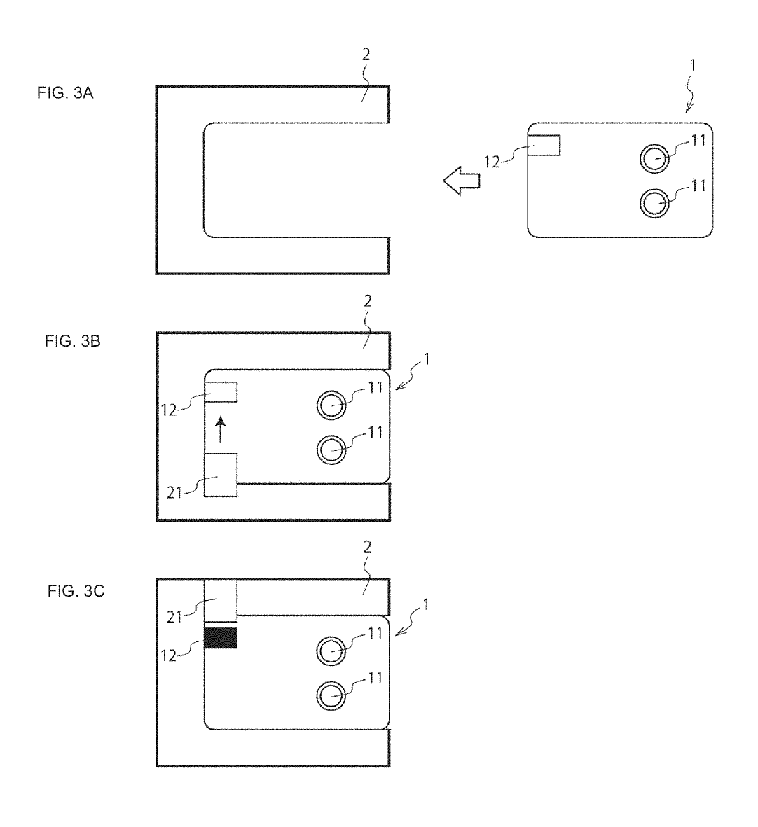

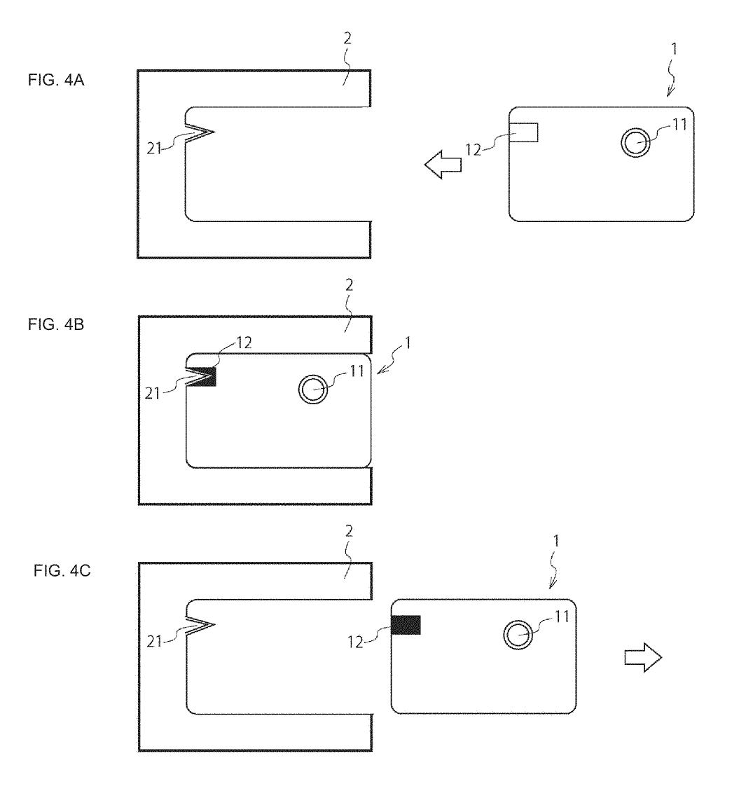

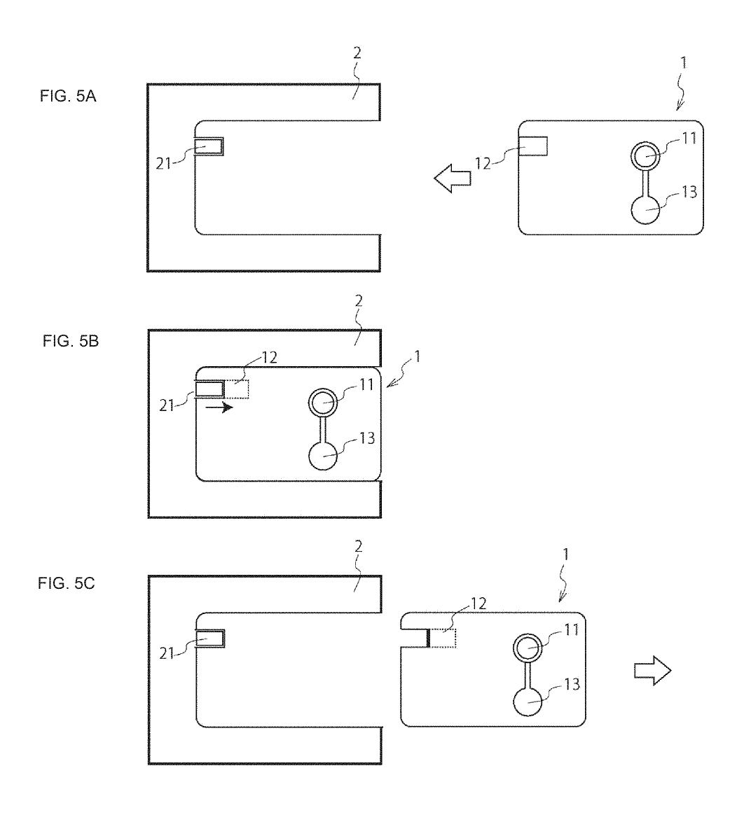

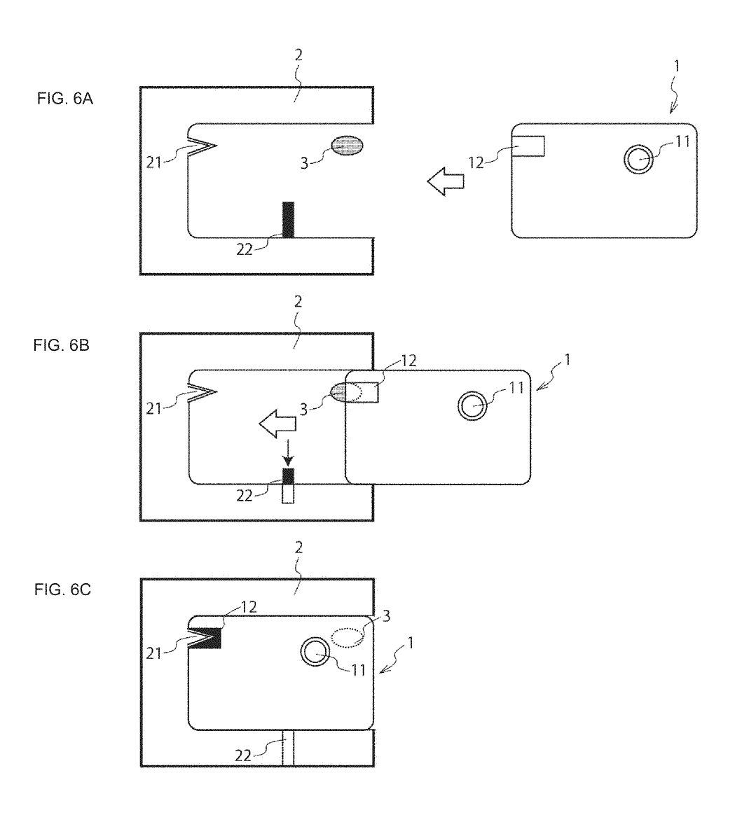

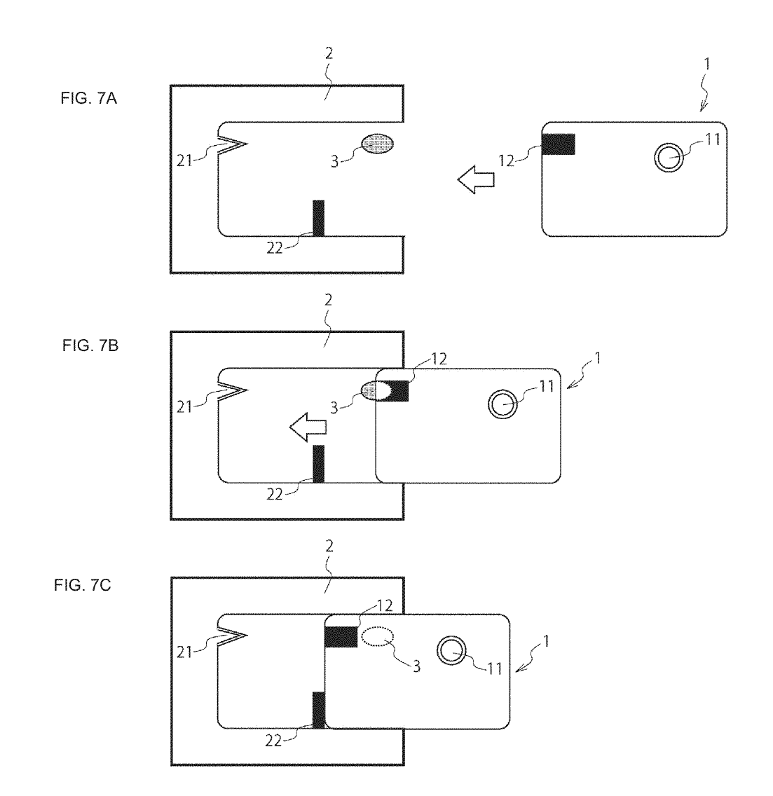

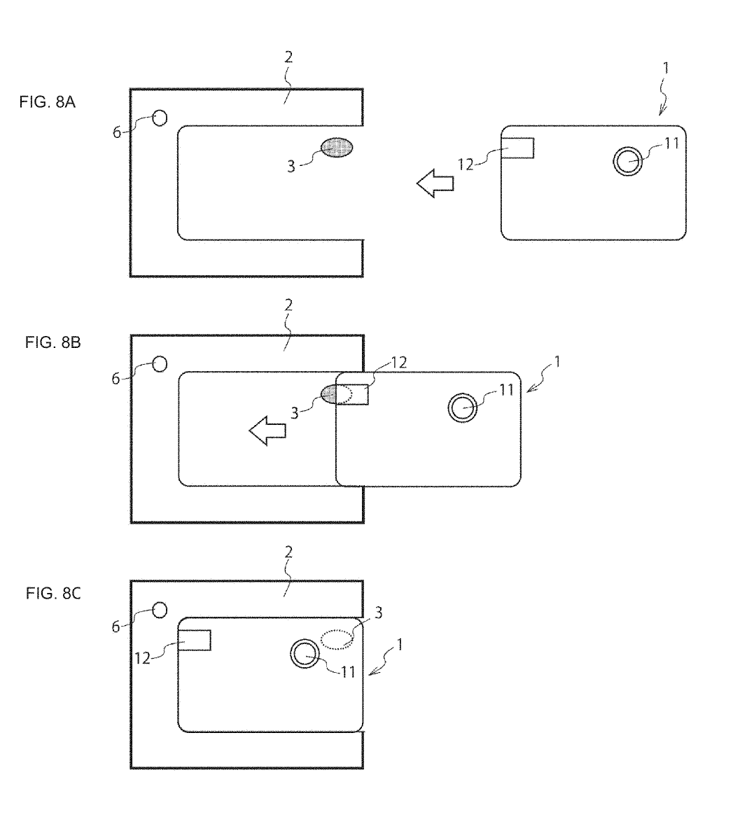

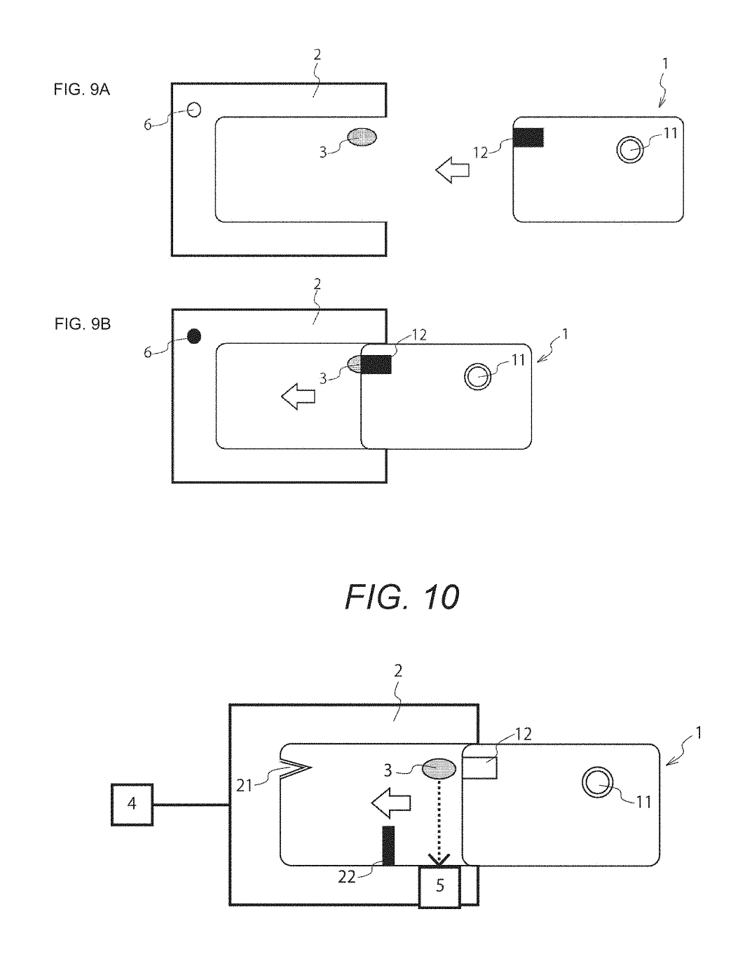

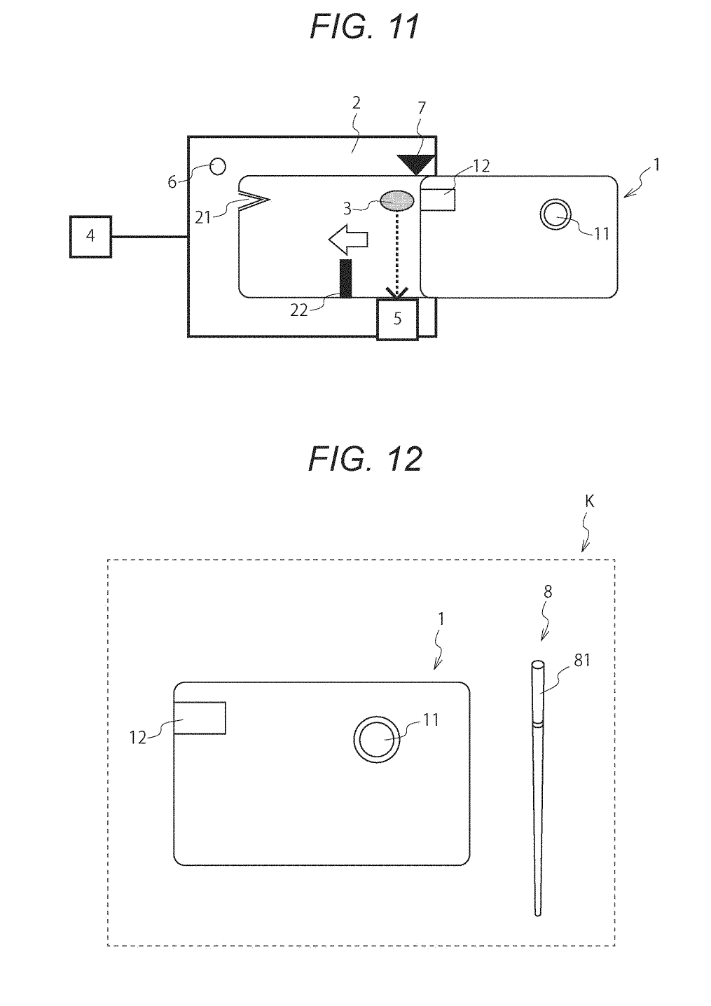

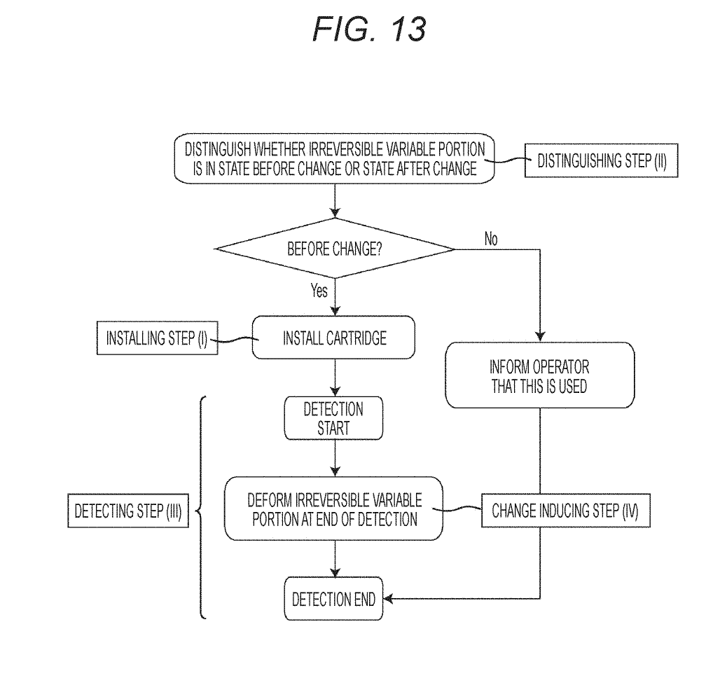

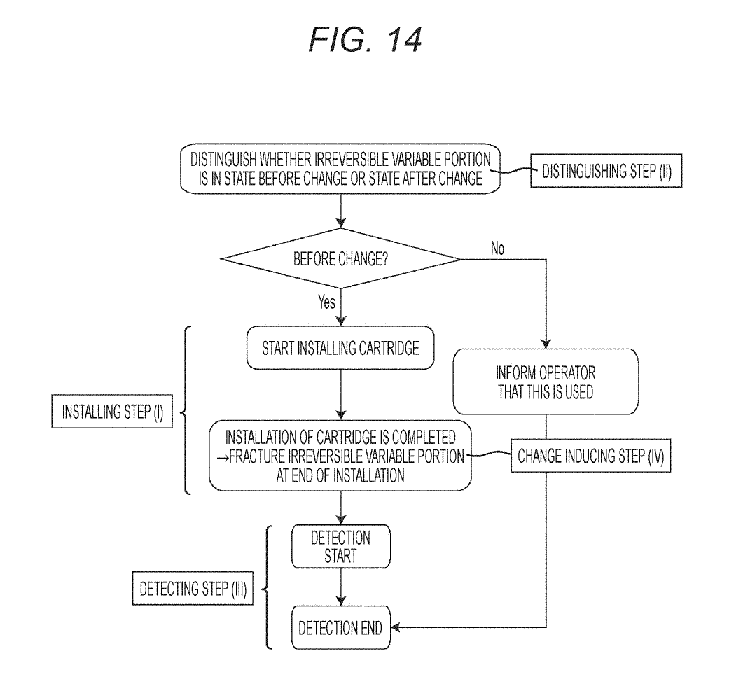

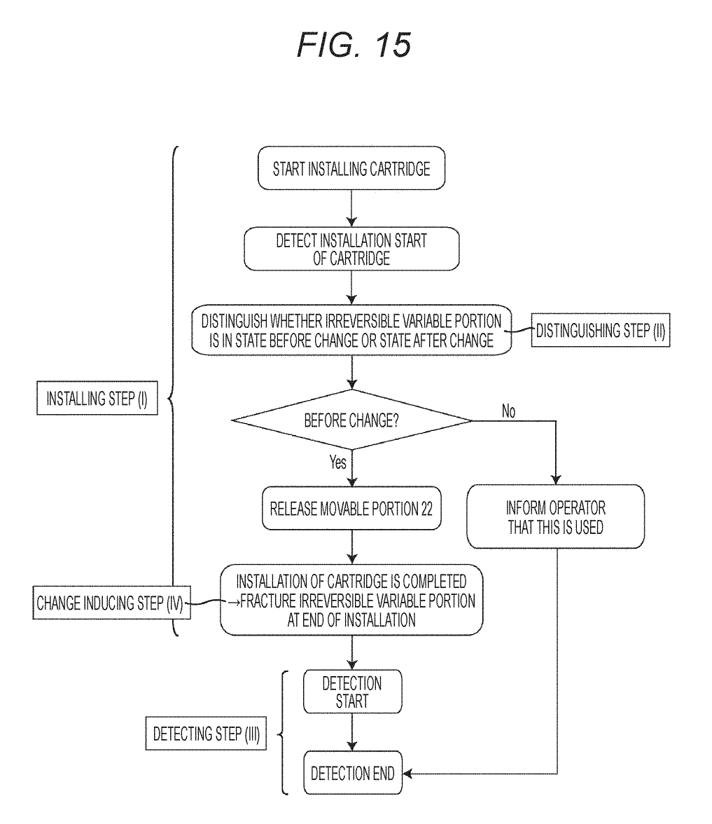

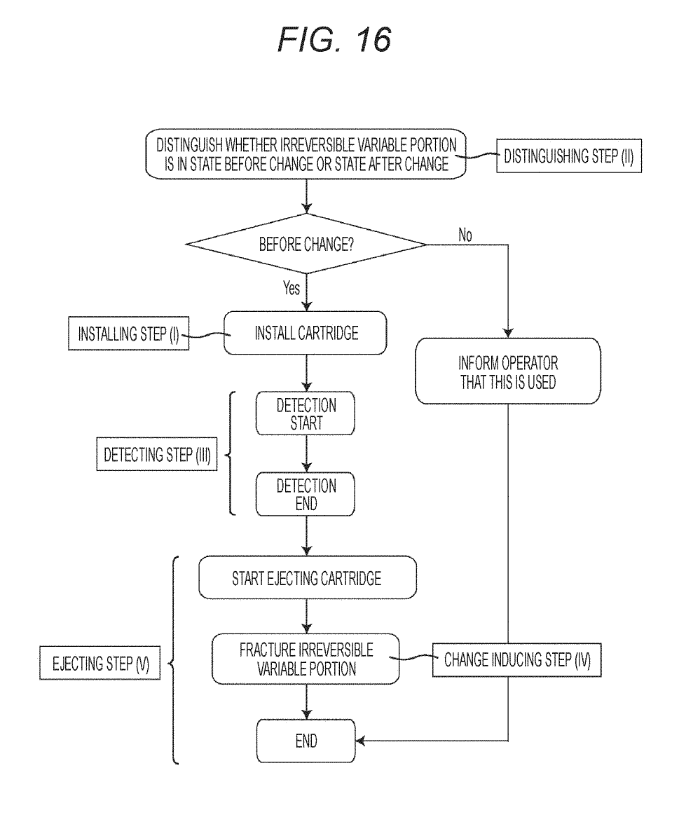

FIG. 2 is a schematic conceptual diagram schematically illustrating a first embodiment of a detecting device 10 according to the present technology.

Meanwhile, although the cartridge 1 according to the present technology is used as a matter of convenience in FIGS. 2 to 11, the cartridge is not limited to the cartridge 1 in the detecting device 10 according to the present technology.

The detecting device 10 according to the present technology is at least provided with a cartridge installing portion 2, a distinguishing unit 3, and a detecting unit 4. Also, as necessary, this may also be further provided with a change inducing unit 21, a movable portion 22, a control unit 5, a distinguishing result display unit 6, a cartridge installation detecting unit 7, a user interface, an analyzing unit and the like.

Hereinafter, each portion is described in detail.

(1) Cartridge Installing Portion 2

The cartridge installing portion 2 is a portion where the cartridge is installed. In the detecting device according to the present technology, the cartridge is not especially limited, and the cartridge 1 according to the present technology may be preferably used. Also, in the present technology, the cartridge installing portion 2 may be freely designed according to a form and the like of the cartridge to be installed.

The cartridge installing portion 2 may further be provided with a temperature adjusting mechanism. In the present technology, the temperature adjusting mechanism is a mechanism which keeps temperature of the sample held by the sample holding unit 11 constant. By including the temperature adjusting mechanism, the temperature of the sample becomes constant, and a measurement error and the like caused by temperature change of the sample may be decreased. A specific configuration of the temperature adjusting mechanism is not especially limited; for example, the cartridge installing portion 2 is formed with a material which may keep heat.

(a) Change Inducing Unit 21

In the present technology, as illustrated in FIGS. 3 to 5 and the like, the cartridge installing portion 2 may further be provided with the change inducing unit 21. The change inducing unit 21 is a portion which induces the physical change of the irreversible variable portion 12. Since the cartridge installing portion 2 is provided with the change inducing unit 21, a configuration of the detecting device 10 is simplified, which contributes to downsizing and a decrease in cost of the device 10.

A form, a structure and the like of the change inducing unit 21 are not especially limited, and there may be a scanner provided with means of deforming, breaking and the like the irreversible variable portion 12 as illustrated in FIG. 3 (for example, optical means such as a laser), and the protruding structure and the like illustrated in FIGS. 4 and 5, for example.

Also, a method of inducing the physical change is not especially limited, and there may be a method of fracturing, breaking and the like the irreversible variable portion 12 by physical means such as the protruding structure, a method of deforming, breaking and the like the irreversible variable portion 12 by the optical means such as the laser, for example.

A specific example of a flow in which the change inducing unit 21 induces the physical change of the irreversible variable portion 12 is hereinafter described in detail with reference to the drawings.

A to C of FIG. 3 are schematic diagrams illustrating a state when the cartridge 1 (unused) according to the present technology is installed in the cartridge installing portion 2.

In the present technology, for example, there is a method of installing the cartridge 1 (unused) in the cartridge installing portion 2 as illustrated in A of FIG. 3, and scanning the same by a scanner (change inducing unit 21) provided with means of deforming, breaking and the like the irreversible variable portion 12 (for example, the optical means such as the laser) provided in the cartridge installing portion 2 as illustrated in B of FIG. 3, thereby deforming, breaking and the like the irreversible variable portion 12 as illustrated in C of FIG. 3.

Also, although not illustrated, there may be a method of deforming, breaking and the like the irreversible variable portion 12 by irradiating the irreversible variable portion 12 with the laser and the like (change inducing unit 21) provided in the cartridge installing portion 2, for example. Also, in a case where the current fuse is provided in at least a part of the irreversible variable portion 12, there also is a method of applying current by means of applying the current (change inducing unit 21) provided in the cartridge installing portion 2, thereby burning the irreversible variable portion 12.

In the present technology, it is preferable that the irreversible physical change occurs at the end of the detection in a case where means which is not directly brought into contact with the irreversible variable portion 12 such as the optical means such as the laser, and the current is made the change inducing unit 21. Means such as the optical means such as the laser and the current might also affect other parts of the cartridge, and if these means are used at the beginning or in the middle of the detection, a measurement error, measurement impossibility and the like might cause.

A to C of FIG. 4 are schematic diagrams illustrating a state in which the cartridge 1 (unused) according to the present technology is installed in the cartridge installing portion 2 different from that in FIG. 3.

In the present technology, for example, in addition to the above-described specific example, there is a method in which the protruding structure (change inducing unit 21) is provided in the cartridge installing portion 2 as illustrated in A of FIG. 4, and the protruding structure fractures, breaks and the like the irreversible variable portion 12 when the cartridge 1 (unused) is inserted at the back of the cartridge installing portion 2 as illustrated in B and C of FIG. 4 and the like.

A to C of FIG. 5 are schematic diagrams illustrating a state in which the cartridge 1 (unused) according to the present technology is installed in the cartridge installing portion 2 different from those in FIGS. 3 and 4.

In the present technology, for example, there also is a method in which the protruding structure (change inducing unit 21) is provided in the cartridge installing portion 2 as illustrated in A of FIG. 5, and the protruding structure pushes and the like the irreversible variable portion 12, such that at least a part of the irreversible variable portion 12 is recessed, deformed and the like when the cartridge 1 (unused) is inserted at the back of the cartridge installing portion 2 as illustrated in B and C of FIG. 5 and the like.

(b) Movable Portion 22

In the present technology, as illustrated in FIGS. 6, 7 and the like, the cartridge installing portion 2 may further be provided with the movable portion 22. The movable portion 22 is a portion movable according to a distinguishing result of the distinguishing unit 3 to be described later. Also, the movable portion 22 is characterized in preventing the cartridge from being installed in the cartridge installing portion 2 in a case where the irreversible variable portion 12 is in a state after change. Since the cartridge installing portion 2 is provided with the movable portion 22, it is possible to more certainly prevent the used cartridge from being reinstalled in the cartridge installing portion 2. Also, since the operator does not have to confirm the distinguishing result by visual and acoustic confirmation and the like, convenience of the operator also improves. Furthermore, even if the confirmation by the operator is missed, since the movable portion 22 automatically prevents the installation of the used cartridge, occurrence of a human error may also be prevented.

A to C of FIG. 6 are schematic diagrams illustrating a state when the cartridge 1 (unused) according to the present technology is installed in the cartridge installing portion 2 different from those in FIGS. 3 to 5. Also, A to C of FIG. 7 are schematic diagrams illustrating a state when the cartridge 1 (used) according to the present technology is about to be installed in the cartridge installing portion 2.

As illustrated in A of FIG. 6, in a case where the irreversible variable portion 12 is in a state before change, if it is determined by the distinguishing unit 3 that this is in the state before change, the movable portion 22 is released as illustrated in B of FIG. 6, and the installation of the cartridge 1 becomes possible as illustrated in C of 6.

On the other hand, as illustrated in A of FIG. 7, in a case where the irreversible variable portion 12 is in the state after change, if it is determined by the distinguishing unit 3 that this is in the state after change, the movable portion 22 is not released as illustrated in B of FIG. 7, and the installation of the cartridge 1 is prevented as illustrated in C of 7.

In the present technology, the movable portion 22 may be freely designed in accordance with the form and the like of the cartridge 1, and this may be made a block structure and the like as illustrated in FIGS. 6, 7 and the like, for example. Also, a method of preventing the installation of the cartridge 1 in the cartridge installing portion 2 is also not especially limited, and there may be a method in which the block structure is provided in an installing direction of the cartridge 1, thereby preventing the cartridge 1 from being installed at the back of the cartridge installing portion 2 and the like, for example, as illustrated in FIG. 7.

(2) Distinguishing Unit 3

The distinguishing unit 3 is a portion which distinguishes whether the irreversible variable portion 12 of the cartridge is in the state before change or the state after change. Since the distinguishing unit 3 is provided, it is possible to automatically distinguish whether the cartridge is used. Therefore, it is not required for the operator to distinguish whether the cartridge is used, and it becomes possible to easily prevent the erroneous reuse of the used cartridge. Also, since it is possible to save time and labor for confirming whether the cartridge is used, troublesome operation may also be prevented.

In the present technology, the distinguishing unit 3 may be, for example, optical means such as a sensor and the like, and its form and the like is not especially limited and may be freely designed.

In the present technology, an installing location of the distinguishing unit 3 is not especially limited. For example, the distinguishing unit 3 may be provided outside the cartridge installing portion 2 as illustrated in FIG. 2, and the distinguishing unit 3 may be provided inside the cartridge installing portion 2 as illustrated in FIGS. 8, 9 and the like; however, in the present technology, it is preferable that the distinguishing unit 3 is provided inside the cartridge installing portion 2. As a result, the configuration of the detecting device 10 is simplified, which contributes to the downsizing and the decrease in cost of the device 10. Also, in the present technology, it is more preferable that the distinguishing unit 3 is provided in the vicinity of an opening of the cartridge installing portion 2. As a result, it becomes possible to distinguish before the cartridge 1 is installed at the back of the cartridge installing portion 2, and the convenience of the operator is improved.

A specific example of a flow in which the distinguishing unit 3 distinguishes whether the irreversible variable portion 12 is in the state before change or the state after change is hereinafter described in detail with reference to the drawings.

A to C of FIG. 8 are schematic diagrams illustrating a state when the cartridge 1 (unused) according to the present technology is installed in the cartridge installing portion 2 different from those in FIGS. 3 to 6. Also, A and B of FIG. 9 are schematic diagrams illustrating a state when the cartridge 1 (used) according to the present technology is about to be installed in the cartridge installing portion 2 different from that in FIG. 7. In the present technology, as illustrated in FIGS. 8 and 9, the distinguishing unit 3 may operate along with the distinguishing result display unit 6 to be described later.

In the present technology, for example, the distinguishing unit 3 is installed in the vicinity of the opening of the cartridge installing portion 2 as illustrated in A of FIG. 8, and the optical means such as the sensor (distinguishing unit 3) distinguishes the irreversible variable portion 12 as illustrated in B of FIG. 8. In the detecting device according to the present technology, it may configure such that, in a case where the irreversible physical change does not occur in the irreversible variable portion 12, for example, a lamp (distinguishing result display unit 6) does not react as illustrated in C of FIG. 8. Then, the operator who visually confirms that the lamp does not react completes the installation of the cartridge 1, and starts detection, analysis and the like as illustrated in C of FIG. 8.

On the other hand, it is possible to configure such that, in a case where the irreversible physical change occurs in the irreversible variable portion 12, for example, the lamp (distinguishing result display unit 6) reacts as illustrated in B of FIG. 9. Then, as illustrated in B of FIG. 9, the operator who visually confirms that the lamp turns on, changes color and the like recognizes that the cartridge 1 is used and stops the installation.

(3) Detecting Unit 4

The detecting unit 4 is a portion which detects the detection target substance contained in the sample held by the sample holding unit of the cartridge. In the present technology, a form and the like of the detecting unit 4 is not especially limited and may be freely designed.

The detection target substance is not especially limited, and examples thereof include a substance contained in the sample, a substance obtained by chemically modifying the substance or the like, for example. Also, a detecting method is not especially limited, and there may be an optical detecting method such as a photothermal conversion detecting method, a fluorescence method, an absorbance method, and a chemiluminescence method, an electrochemical detecting method using a detecting electrode, a blood cell count measuring method by change in electric resistance value, a blood cell count measuring method by scattering, an immunological detecting method by counting immunoassay and the like.

(4) Control Unit 5

The detecting device 10 according to the present technology may further be provided with the control unit 5 as illustrated in a second embodiment in FIG. 10. The control unit 5 is a portion which controls to start detecting on the basis of the distinguishing result of the distinguishing unit 3. Also, the control unit 5 is characterized by not starting detecting in a case where the irreversible variable portion is in the state after change. By including the control unit 5, it is possible to more certainly prevent the start of the detection, analysis and the like using the used cartridge. Also, even if the operator does not confirm the distinguishing result by visual, acoustic confirmation and the like, the detection, analysis and the like are not automatically started in a case of the used cartridge, so that it is possible to save time and effort of the operator and the convenience is also improved.

In the present technology, a form and the like of the control unit 5 is not especially limited and may be freely designed. Also, a method of controlling the start of the detection is also not especially limited. An installing location of the control unit 5 is not especially limited, and for example, as illustrated in FIG. 10, the control unit 5 may be provided inside the cartridge installing portion 2.

(5) Distinguishing Result Display Unit 6

As illustrated in a third embodiment in FIG. 11, the detecting device 10 according to the present technology may further be provided with the distinguishing result display unit 6. The distinguishing result display unit 6 is a portion which displays the distinguishing result of the distinguishing unit 3. By including the distinguishing result display unit 6, the operator may visually confirm the distinguishing result of the distinguishing unit 3, so that the convenience of the operator is improved.

In the present technology, a form and the like of the distinguishing result display unit 6 is not especially limited and may be freely designed, and the above-described lamp (refer to FIGS. 8 and 9), a display and the like may be used, for example. Also, in a case where the display and the like is used as the distinguishing result display unit 6, it is also possible to display the result of the detection, analysis and the like and all items related to the detection and the like together. An installing location of the distinguishing result display unit 6 is not especially limited, and for example, as illustrated in FIG. 11 and the like, the distinguishing result display unit 6 may be provided in the cartridge installing portion 2.

The distinguishing result display unit 6 is not indispensable in the detecting device 10 according to the present technology, and it is also possible to display the distinguishing result by using an external display device and the like, for example.

Also, in the detecting device according to the present technology, a mechanism of informing the operator of the distinguishing result on whether the cartridge is used is not especially limited. In addition to a mechanism of informing through a visual sense of the operator by the distinguishing result display unit 6, for example, there may be a mechanism of informing through an acoustic sense of the operator by sounding a buzzer and the like, a mechanism of informing through both the visual and acoustic senses of the operator and the like.

Also, it is configured such that the lamp (distinguishing result display unit 6) does not react in a case where the irreversible physical change does not occur in the irreversible variable portion 12 in the examples illustrated in FIGS. 8 and 9; however, in the present technology, the opposite thereof (the lamp reacts and the like in a case where the physical change does not occur in the irreversible variable portion 12) is also possible. Also, a portion reacting in a case where the physical change does not occur or occurs is not necessarily the distinguishing result display unit 6, and the distinguishing unit 3 itself may react by lighting, changing color, emitting sound and the like, or a portion provided in addition to that and the like may react.

(6) Cartridge Installation Detecting Unit 7

The detecting device 10 according to the present technology may further be provided with the cartridge installation detecting unit 7 as illustrated in the third embodiment in FIG. 11. The cartridge installation detecting unit 7 is a portion which detects installation start of the cartridge. By including the cartridge installation detecting unit 7, for example, it is possible to adopt a configuration in which, when the cartridge installation detecting unit 7 detects that the installation of the cartridge is started, the distinguishing unit 3 moves along with this, and the distinguishing unit 3 starts distinguishing to the present technology.

In the present technology, a form and the like of the cartridge installation detecting unit 7 is not especially limited and may be freely designed. Also, a method of detecting the installation of the cartridge 1 is not especially limited, and examples thereof include optical means and the like such as a sensor, for example. An installing location of the cartridge installation detecting unit 7 is also not especially limited, and for example, as illustrated in FIG. 11, the cartridge installation detecting unit 7 may be provided in the vicinity of the opening of the cartridge installing portion 2.

The cartridge installation detecting unit 7 is not indispensable in the detecting device 10 according to the present technology, and it is also possible to further give a function of detecting the installation start of the cartridge to the distinguishing unit 3 described above, for example.

(7) User Interface

The detecting device 10 according to the present technology may further be provided with the user interface. The user interface is a portion to be operated by a user (for example, the operator). The user may access each part of the detecting device 10 according to the present technology through the user interface.

As the user interface, for example, a mouse, a keyboard and the like may be used. The user interface is not indispensable in the detecting device 10 according to the present technology, and it is also possible to operate by using an external operating device and the like, for example.

(8) Analyzing Unit

The detecting device 10 according to the present technology may further be provided with the analyzing unit. The analyzing unit is a portion which analyzes/determines a physical property of the sample, notifies of a determination result and the like on the basis of information of the sample detected by the detecting unit 4. The analyzing unit is not indispensable in the detecting device 10 according to the present technology, and it is also possible to analyze using an external analyzing device and the like, for example.

(9) Others

The cartridge 1 according to the present technology described above may be preferably used especially in a device which optically analyzes a liquid-state sample. Therefore, the detecting device 10 according to the present technology may be provided with various structures provided in a well-known optical analyzing device. Examples of the various structures include a light irradiating unit, an optical controlling mechanism, a light detecting unit and the like, for example.

(a) Light Irradiating Unit

The light irradiating unit is a portion for irradiating the sample held by the sample holding unit 11 of the cartridge 1 with light. A light irradiating method which may be used for the light irradiating unit is not especially limited, and any well-known light irradiating method may be freely selected and used. For example, one or two more light irradiating methods using a light emitting diode (LED), a semiconductor laser, EL illumination and the like may be freely selected and used.

Also, a specific arranging method of the light irradiating unit is also not especially limited as long as the sample may be irradiated with light, and this may be arranged freely. For example, light irradiation may be performed from above, below and the like of the cartridge 1.

Also, the light irradiating unit may be freely set according to a function of the optical controlling mechanism to be described later. For example, in a case where a dichroic mirror and the like are used as the optical controlling mechanism, it is also possible to perform the light irradiation from a side of the cartridge 1.

Furthermore, in a case where there are two or more sample holding units 11 in the cartridge 1, the light irradiating unit may be provided for each sample holding unit 11, but in a case where a light dividing element, a light guide plate and the like is used as the optical controlling mechanism to be described later, it is also possible to design such that one light irradiating unit irradiates a plurality of sample holding units 11 with light.

(b) Optical Controlling Mechanism

The optical controlling mechanism is a mechanism which controls an optical path of the light (for example, excitation light EL and the like) emitted from the light irradiating unit described above.

As the optical controlling mechanism, one or two or more types of controlling mechanisms used in the well-known optical analyzing device may be freely combined to be used. For example, a lens such as a collimator lens and a condenser lens, a mirror such as a dichroic mirror, an optical filter, an aperture and the like, a light dividing element, a light guide plate, a partition wall and the like may be used as necessary.

(c) Light Detecting Unit

The light detecting unit is a portion which detects light (for example, scattered light SL and the like) emitted from the sample by the light irradiation. Meanwhile, in the present technology, the detecting unit 4 described above may be used as the light detecting unit.

A light detecting method which may be used for the light detecting unit is not especially limited, and any well-known light detecting method may be freely selected and used. For example, a method using an area image sensor such as a photo diode (PD), a charge coupled device (CCD), and a complementary metal oxide semiconductor (CMOS), a method using a so-called multichannel light detector in which a plurality of light detectors is arranged in an array pattern and the like may be adopted.

Also, a specific method of arranging the light detecting unit is not especially limited as long as the light detection from the sample is possible, and it is possible to freely arrange. For example, light detection may be performed from above, below and the like of the cartridge 1.

Also, the light detecting unit may be freely designed according to the function of the optical controlling mechanism described above. For example, in a case where a dichroic mirror and the like are used as the optical controlling mechanism, it is also possible to perform the light detection from the side of the cartridge 1.

Furthermore, in a case where there are two or more sample holding units 11 in the cartridge 1, the light detecting unit may be provided for each sample holding unit 11, but it is also possible to design such that the light detection is performed from a plurality of sample holding units 11 by allowing one light detecting unit to scan.

<3. Detecting Kit K>

FIG. 12 is a schematic diagram schematically illustrating a first embodiment of a detecting kit K according to the present technology.

Meanwhile, although the cartridge 1 of the first embodiment described above (refer to FIG. 1) is used in FIG. 12 as a matter of convenience, in the detecting kit K, the form of the cartridge 1 is not limited to this.

The detecting kit K according to the present technology is roughly provided with at least the above-described cartridge 1 and a sample introducing member 8.

Meanwhile, since the cartridge 1 is similar to that described above, this is not herein described.

(1) Sample Introducing Member 8

The sample introducing member 8 is a member for introducing the sample into the sample holding unit 11. Although a form of the sample introducing member 8 is not especially limited, for example, examples thereof include a capillary (capillary tube) 81 and the like as illustrated in the first embodiment in FIG. 12.

Also, the sample introducing member 8 may be made disposable as the cartridge 1. By making the sample introducing member 8 disposable, it is possible to save time and labor of cleaning and the like of tools used for introducing the sample, so that the convenience of the operator may be improved, and efficiency in the detection, analysis and the like may be realized. Also, a risk of reusing the sample introducing member 8 may be decreased.

<4. Detecting Method>

A detecting method according to the present technology at least performs an installing step (I), a distinguishing step (II), and a detecting step (III). Also, if necessary, a change inducing step (IV), an ejecting step (V) and the like may further be carried out.

Hereinafter, each step is described in detail.

(1) Installing Step (I)

The installing step (I) is a step of installing the cartridge in the detecting device. In the detecting method according to the present technology, the cartridge is not especially limited; the cartridge 1 according to the present technology may be preferably used. Since the installing step (I) is the same as the method performed by the cartridge installing portion 2 of the detecting device 10 described above, for example, the description thereof is herein omitted.

(2) Distinguishing Step (II)

The distinguishing step (II) is a step of distinguishing whether the irreversible variable portion of the cartridge is in a state before change or a state after change. Since the distinguishing step (II) is the same as the method performed by the distinguishing unit 3 of the detecting device 10 described above, for example, the description thereof is herein omitted. In the present technology, it is possible to automatically distinguish whether the cartridge is used by performing the distinguishing step (II). Therefore, it is not required for the operator to distinguish whether the cartridge is used, and it becomes possible to easily prevent the erroneous reuse of the used cartridge. Also, since it is possible to save time and labor for confirming whether the cartridge is used, troublesome operation may also be prevented.

(3) Detecting Step (III)

The detecting step (III) is a step of detecting the detection target substance contained in the sample held by the sample holding unit of the cartridge. Since the detecting step (III) is the same as the method performed by the detecting unit 4 of the detecting device 10 described above, for example, the description thereof is herein omitted.

(4) Change Inducing Step (IV)

In the detecting method according to the present technology, the change inducing step (IV) may further be performed. The change inducing step (IV) is performed at least after the distinguishing step (II), and is a step of inducing the physical change of the irreversible variable portion. Since the change inducing step (IV) is the same as the method performed by the change inducing unit 21 of the detecting device 10 described above, for example, the description thereof is herein omitted. In the present technology, by performing the change inducing step (IV), it is possible to simplify the detecting method according to the present technology, and it is possible to prevent troublesome operation by the operator.

(5) Ejecting Step (V)

In the detecting method according to the present technology, the ejecting step (V) may further be performed. The ejecting step (V) is a step of ejecting the cartridge from the detecting device. The ejecting step (V) is characterized by being carried out simultaneously with the change inducing step (IV). Since the ejecting step (V) is performed simultaneously with the change inducing step (IV), convenience for the operator is improved.

In the present technology, the method of ejecting the cartridge from the detecting device is not especially limited; the operator may manually eject the cartridge from the detecting device, or the cartridge may be automatically ejected from the detecting device.

Hereinafter, an example of a flow of the detection using the detecting method according to the present technology is described with reference to FIGS. 13 to 16.

FIG. 13 is a flowchart illustrating an example of the flow of the detection using the detecting method according to the present technology.

In the present technology, as illustrated in FIG. 13, the change inducing step (IV) may be performed at the same time as the detecting step (III). In the example illustrated in FIG. 13, the distinguishing step (II) is carried out, and if the irreversible variable portion 12 is in a state before change, the installing step (I) is carried out. In the present technology, it is also possible to perform the distinguishing step (II) before the installing step (I) as illustrated in FIG. 13 and the like. After the installing step (I), the detection of the sample is started, the irreversible variable portion of the cartridge is deformed and the like at the end of the detection (refer to FIG. 3 also), for example, and the change inducing step (IV) is carried out simultaneously with the detecting step (III).

On the other hand, in a case where the irreversible variable portion is in the state after change, it is determined that the cartridge is used, and the operator is informed of this.

FIG. 14 is a flowchart illustrating an example of the flow of the detection using the detecting method according to the present technology different from that in FIG. 13.

In the present technology, as illustrated in FIG. 14, the change inducing step (IV) may be performed at the same time as the installing step (I). In the example illustrated in FIG. 14, the distinguishing step (II) is carried out, and in a case where the irreversible variable portion 12 is in the state before change, the installing step (I) is started. Then, the irreversible variable portion is fractured at the end of the installation of the cartridge (refer to FIG. 4 also) and the like, and the change inducing step (IV) is performed at the same time as the installing step (I), for example. After the installing step (I), the detecting step (III) is performed.

On the other hand, in a case where the irreversible variable portion is in the state after change, it is determined that the cartridge is used as in FIG. 13, and the operator is informed of this.

FIG. 15 is a flowchart illustrating an example of the flow of the detection using the detecting method according to the present technology different from those in FIGS. 13 and 14.

In the present technology, as illustrated in FIG. 15, the distinguishing step (II) and the change inducing step (IV) may be performed at the same time as the installing step (I). In the example illustrated in FIG. 15, the installing step (I) is started to detect the start of the installation of the cartridge. In this manner, in the detecting method according to the present technology, a step of detecting the start of the installation of the cartridge may be provided before the distinguishing step (II). Since the step is the same as the method performed by the cartridge installation detecting unit 7 of the detecting device 10 described above, for example, the description thereof is herein omitted.

Then, the distinguishing step (II) is carried out at the same time as the installing step (I), and in a case where the irreversible variable portion 12 is in the state before change, the movable portion 22 described above is released. In this manner, in the detecting method according to the present technology, a step of releasing the movable portion 22 described above may be provided. Since the step is the same as the method performed by the movable portion 22 described above, for example, the description thereof is herein omitted. Also, in the present technology, a step of controlling the start of the detection in response to a result of the distinguishing step (II) may be provided in place of or in addition to the step of releasing the movable portion 22. Since the step is the same as the method performed by the control unit 5 described above, for example, the description thereof is herein omitted.

After the step of releasing the movable portion 22, the installation of the cartridge is completed, and as illustrated in FIG. 15, the irreversible variable portion is fractured at the end of the installation of the cartridge (refer to FIG. 4 also) and the like and the change inducing step (IV) is performed at the same time as the installing step (I), for example. After the installing step (I), the detecting step (III) is performed.

On the other hand, in a case where the irreversible variable portion is in the state after change, it is determined that the cartridge is used as in FIGS. 13 and 14, and the operator is informed of this.

FIG. 16 is a flowchart illustrating an example of the flow of the detection using the detecting method according to the present technology which is different from those in FIGS. 13 to 15.

In the present technology, as illustrated in FIG. 16, the change inducing step (IV) may be performed at the same time as the ejecting step (V). In the example illustrated in FIG. 16, the distinguishing step (II) is carried out, and in a case where the irreversible variable portion 12 is in the state before change, the installing step (I) is started. After the installing step (I), the detecting step (III) is performed. Thereafter, the ejection of the cartridge is started, and by providing means of breaking the irreversible variable portion and the like in the middle of the cartridge installing portion 2, for example, the irreversible variable portion is broken, and the change inducing step (IV) is performed at the same time as the ejecting step (V).

On the other hand, in a case where the irreversible variable portion is in the state after change, it is determined that the cartridge is used as in FIGS. 13 to 15, and the operator is informed of this.

(6) Others

The cartridge 1 according to the present technology described above may be preferably used especially for a method of optically analyzing the liquid-state sample. Therefore, in the detecting method according to the present technology, various steps performed by the well-known optical analyzing method may be performed. Since the various steps are the same as the methods performed by the light irradiating unit, the optical controlling mechanism, the light detecting unit and the like of the detecting device 10 described above, for example, the description thereof is herein omitted.

Meanwhile, the present technology may also have a following configuration.

(1) A cartridge at least including:

a sample holding unit for holding a sample containing a detection target substance to be detected by a detecting device; and

an irreversible variable portion capable of irreversibly physically changing arranged in a position corresponding to a distinguishing unit of the detecting device when being installed in the detecting device.

(2) The cartridge according to (1),

in which the irreversible variable portion has a fracture structure fractured by installation in the device.

(3) The cartridge according to (2),

in which the fracture structure is a film-shaped structure.

(4) The cartridge according to any one of (1) to (3),

in which the sample is a biological sample.

(5) A detecting device at least including:

a cartridge installing portion in which a cartridge is installed;

a distinguishing unit which distinguishes whether an irreversible variable portion of the cartridge is in a state before change or a state after change; and

a detecting unit which detects a detection target substance contained in a sample held by a sample holding unit of the cartridge.

(6) The detecting device according to (5),

in which a change inducing unit which induces physical change in the irreversible variable portion is provided in the cartridge installing portion.

(7) The detecting device according to (5) or (6),

in which the cartridge installing portion is provided with a movable portion movable according to a distinguishing result of the distinguishing unit, and

the movable portion prevents installation of the cartridge in the cartridge installing portion in a case where the irreversible variable portion is in the state after change.

(8) The detecting device according to any one of (5) to (7), further including:

a control unit which controls start of detection on the basis of a distinguishing result of the distinguishing unit,

in which the control unit does not start the detection in a case where the irreversible variable portion is in the state after change.

(9) A detecting method at least including:

an installing step of installing a cartridge in a detecting device;

a distinguishing step of distinguishing whether an irreversible variable portion of the cartridge is in a state before change or a state after change; and

a detecting step of detecting a detection target substance contained in a sample held by a sample holding unit of the cartridge.

(10) The detecting method according to (9), further including:

a change inducing step performed at least after the distinguishing step and inducing physical change in the irreversible variable portion.

(11) The detecting method according to (9) or (10),

in which the change inducing step is performed simultaneously with the detecting step.

(12) The detecting method according to any one of (9) to (11),

in which the change inducing step is performed simultaneously with the installing step.

(13) The detecting method according to any one of (9) to (12),

in which the distinguishing step and the change inducing step are performed simultaneously with the installing step.

(14) The detecting method according to any one of (9) to (13), further including:

an ejecting step of ejecting the cartridge from the detecting device,

in which the change inducing step is performed simultaneously with the ejecting step.

### REFERENCE SIGNS LIST

1 Cartridge
11 Sample holding unit
12 Irreversible variable portion
13 Reagent holding unit
10 Detecting device
2 Cartridge installing portion
21 Change inducing unit
22 Movable portion
3 Distinguishing unit
4 Detecting unit
5 Control unit
6 Distinguishing result display unit
7 Cartridge installation detecting unit
K Detecting kit
8 Sample introducing member
81 Capillary (capillary tube)

1. A cartridge at least comprising:
a sample holding unit for holding a sample containing a detection target substance to be detected by a detecting device; and
an irreversible variable portion capable of irreversibly physically changing arranged in a position corresponding to a distinguishing unit of the detecting device when being installed in the detecting device.

2. The cartridge according to claim 1,
wherein the irreversible variable portion has a fracture structure fractured by installation in the device.

3. The cartridge according to claim 2,
wherein the fracture structure is a film-shaped structure.

4. The cartridge according to claim 1,
wherein the sample is a biological sample.

5. A detecting device at least comprising:
a cartridge installing portion in which a cartridge is installed;
a distinguishing unit which distinguishes whether an irreversible variable portion of the cartridge is in a state before change or a state after change; and
a detecting unit which detects a detection target substance contained in a sample held by a sample holding unit of the cartridge.

6. The detecting device according to claim 5,
wherein a change inducing unit which induces physical change in the irreversible variable portion is provided in the cartridge installing portion.

7. The detecting device according to claim 5,
wherein the cartridge installing portion is provided with a movable portion movable according to a distinguishing result of the distinguishing unit, and
the movable portion prevents installation of the cartridge in the cartridge installing portion in a case where the irreversible variable portion is in the state after change.

8. The detecting device according to claim 5, further comprising:
a control unit which controls start of detection on the basis of a distinguishing result of the distinguishing unit,
wherein the control unit does not start the detection in a case where the irreversible variable portion is in the state after change.

9. A detecting method at least comprising:
an installing step of installing a cartridge in a detecting device;
a distinguishing step of distinguishing whether an irreversible variable portion of the cartridge is in a state before change or a state after change; and
a detecting step of detecting a detection target substance contained in a sample held by a sample holding unit of the cartridge.

10. The detecting method according to claim 9, further comprising:
a change inducing step performed at least after the distinguishing step and inducing physical change in the irreversible variable portion.

11. The detecting method according to claim 9,
wherein the change inducing step is performed simultaneously with the detecting step.

12. The detecting method according to claim 9,
wherein the change inducing step is performed simultaneously with the installing step.

13. The detecting method according to claim 9,
wherein the distinguishing step and the change inducing step are performed simultaneously with the installing step.

14. The detecting method according to claim 9, further comprising:
an ejecting step of ejecting the cartridge from the detecting device,
wherein the change inducing step is performed simultaneously with the ejecting step.
